(19) United States
(12) Patent Application Publication
(10) Pub. No.: US 2024/0425021 A1
(43) Pub. Date: Dec. 26, 2024

(54) METHOD AND SYSTEM FOR OPERATING A VEHICLE COMBINATION

(71) Applicant: ZF Friedrichshafen AG, Friedrichshafen (DE)

(72) Inventors: Henning SONNENBURG, Ravensburg (DE); Gianantonio BORTOLIN, Wasserburg (DE); Udo GILLICH, Tettnang (DE); Fred SCHMIDT, Maxsain (DE)

(73) Assignee: ZF Friedrichshafen AG, Friedrichshafen (DE)

(21) Appl. No.: 18/748,731

(22) Filed: Jun. 20, 2024

(30) Foreign Application Priority Data
Jun. 22, 2023 (DE) 10 2023 205 867.7

(51) Int. Cl. B60T 8/17; B60D 1/24; B60T 7/20; B60T 8/171; B60T 8/172; B60T 8/58

(52) U.S. Cl. CPC B60T 8/1701; B60D 1/24; B60T 7/20; B60T 8/171; B60T 8/172; B60T 8/58; B60T 2201/06; B60T 2210/20; B60T 2250/00

(57) ABSTRACT

A method for operating a vehicle combination (2) on a longitudinally inclined roadway (4) can be carried out when the vehicle combination (2) is located on the longitudinally inclined roadway (4). The method includes detecting a tensile or compressive force acting on a trailer drawbar (12) of a vehicle trailer (10) of the vehicle combination (2) using a force sensor (22) arranged on the trailer drawbar (12); generating a brake signal as a function of the detected tensile or compressive force; and controlling a mechanical friction brake (32) of the vehicle trailer (10) based on the generated brake signal for providing a braking force acting on the vehicle trailer (10). In addition, a system (200) for carrying out the method, a vehicle trailer (10) having such a system (200), and a vehicle combination (2) having such a vehicle trailer (10) are disclosed.

### RELATED APPLICATIONS

This application claims the benefit of and right of priority under 35 U.S.C. § 119 to German Patent Application no. 10 2023 205 867.7, filed on 22 Jun. 2023, the contents of which are incorporated herein by reference in its entirety.

### TECHNICAL FIELD

The present invention relates to a method and system for operating a vehicle combination on a longitudinally inclined roadway. The invention in addition relates to a vehicle trailer having such a system. The invention further relates to a vehicle combination having such a vehicle trailer.

### BACKGROUND

Vehicle trailers having an overrun device are known from the prior art. In the case of known trailers that are overrun-braked in this way, a braking force acting on the trailer is mechanically affected when the towing vehicle is slowed. It is known from EP 3 600 982 A1 and DE 10 2017 103 777 A1 to detect a swerving of a trailer and, based on the detected swerving, to trigger a wheel brake of the trailer in order to reduce the swerving of the trailer.

### SUMMARY

In one aspect, the present invention relates to a method for operating a vehicle combination on a longitudinally inclined roadway. The vehicle combination can comprise at least two vehicles, wherein at least one of the vehicles is a self-propelled vehicle. The vehicle combination can have a towing vehicle to which a vehicle trailer can be attached. The vehicle trailer can be a self-propelled vehicle trailer.

As one step, the method can comprise an operation of the vehicle combination on the longitudinally inclined roadway. The longitudinally inclined roadway can have at least a slope or a gradient, wherein the vehicle combination can be located in the slope or gradient. The steps of the method are carried out when the vehicle combination is located on the longitudinally inclined roadway. When located on the longitudinally inclined roadway, the vehicle combination can be standing still or moving. While standing still or moving, the vehicle combination can be braked by means of a braking force acting on the vehicle combination. The braking force can be generated by a vehicle brake of the vehicle trailer.

As one step, the method comprises a detection of a tensile or compressive force acting on a trailer drawbar of a vehicle trailer of the vehicle combination using a force sensor arranged on the trailer drawbar. The vehicle trailer can be coupled to the towing vehicle of the vehicle combination via the trailer drawbar. The trailer drawbar can form a rigid longitudinal coupling of the vehicle trailer to the towing vehicle.

The tensile force can act on the trailer drawbar when the vehicle combination takes off, when the towing vehicle is accelerated, or when the vehicle trailer is standing still in a slope of the longitudinally inclined roadway. The compressive force can act on the trailer drawbar when the vehicle combination is stopped, when the towing vehicle is decelerated, or when standing still in a gradient of the longitudinally inclined roadway. The force sensor can be arranged on a coupling region of the trailer drawbar via which the trailer drawbar is coupled to the towing vehicle. The force sensor can comprise a spring force meter or a strain gauge, for example. The force sensor can be configured as a tensile force sensor for detecting the tensile force acting on the trailer drawbar of the vehicle trailer. Alternatively, or additionally, the force sensor can be configured as a pressure force sensor for detecting the pressure force acting on the trailer drawbar of the vehicle trailer.

As a further step, the method comprises a generation of a brake signal as a function of the detected tensile or compressive force. The brake signal can be generated by a control device, which can be arranged on the vehicle trailer. The control device can read the detected tensile or compressive force in order to generate the brake signal based on the input tensile or compressive force. The brake signal can be a braking command to decelerate the vehicle trailer.

As a further step, the method comprises a controlling of a mechanical friction brake of the vehicle trailer based on the generated brake signal for providing a braking force acting on the vehicle trailer. The step of controlling the mechanical friction brake can be carried out as a function of the detected tensile or compressive force or the generated brake signal. The step of controlling can comprise an electronic control of the mechanical friction brake. The step of controlling the mechanical friction brake can also be carried out as a step of controlling at least one mechanical friction brake or a plurality of mechanical friction brakes of the vehicle trailer. The mechanical friction brake can be configured so as to decelerate a vehicle wheel of the vehicle trailer. The mechanical friction brake can also be configured so as to decelerate at least one vehicle wheel of the vehicle trailer or a plurality of vehicle wheels. The mechanical friction brake can be controlled in such a way that, based on the generated brake signal, the tensile or compressive force acting on the trailer drawbar is reduced or eliminated. The brake signal can thus be generated in order to reduce or eliminate the detected tensile or compressive force. According to one embodiment, the mechanical friction brake can be triggered for wheel-specific deceleration.

The mechanical friction brake can be an electronically triggerable friction brake, which can be actuated electrically, hydraulically, pneumatically, or mechanically. The vehicle trailer can comprise at least one of the following: an electric actuator, a hydraulic actuator, a pneumatic actuator, or a mechanical actuator for actuating the mechanical friction brake in order to provide the braking force. The step of controlling the mechanical friction brake can thus comprise the controlling of at least one of the following: the electric actuator, the hydraulic actuator, the pneumatic actuator, or the mechanical actuator based on the generated brake signal for providing the braking force acting on the vehicle trailer.

With the method, the vehicle combination can be operated in a force-balanced manner while standing still or moving on the longitudinally inclined roadway. The tensile or compressive force acting on the trailer drawbar can be reduced or eliminated in the force-balanced operation of the vehicle combination. In the force-balanced operation of the vehicle combination, the mechanical friction brake can be controlled in such a way that the braking force acting on the vehicle trailer reduces or eliminates the tensile or compressive force acting on the trailer drawbar. A thrust force or tensile force that can act on the towing vehicle and is caused by the mass and acceleration of the vehicle trailer in the vehicle combination can therefore advantageously be reduced or eliminated with the method. The vehicles of the vehicle combination can therefore be operated in a force-balanced manner on a longitudinally inclined roadway. In addition, due to the vehicle trailer, forces and loads acting on the drive train of the towing vehicle can efficiently be reduced in order to improve the operational mobility and operational safety of the vehicle combination. Furthermore, the method can also provide driving comfort for a driver of the vehicle combination.

According to one embodiment of the method, as a further step, the method can comprise a determination of a force reversal between a tensile force acting on the trailer drawbar and a compressive force acting on the trailer drawbar. An acceleration request or a deceleration request by a driver of the vehicle combination or an acceleration or deceleration that occurs can be detected efficiently. As one step, the method can also comprise a detection of a tensile and compressive force acting on the trailer drawbar of the vehicle trailer of the vehicle combination using the force sensor arranged on the trailer drawbar. The step of determination can be carried out based on the detected tensile and compressive force. In the step of generating the brake signal, the brake signal can be generated as a function of the determined force reversal. A force reversal occurring when the vehicle combination is started or stopped, when the towing vehicle is accelerated or decelerated, or when the vehicle combination is standing still in a slope or gradient can thus be efficiently determined, and the step of controlling the mechanical friction brake can be used as a basis. The force-balanced operation of the vehicle combination can thus be brought about particularly efficiently.

According to a further embodiment of the method, as a further step, it comprises a regulation of the braking force acting on the vehicle trailer based on the generated braking signal for providing the braking force acting on the vehicle trailer. The braking force can be regulated in a control circuit in such a way that, as a function of the detected tensile or compressive force, the acting tensile or compressive force is reduced or eliminated. The force-balanced operation of the vehicle combination can thus be brought about particularly reliably.

According to a further embodiment of the method, as a further step, it comprises a recognition of a slope of the longitudinally inclined roadway on which the vehicle combination is located. The slope can be detected with an inclination sensor arranged on the vehicle trailer. The steps of generating the brake signal and controlling the mechanical friction brake can be carried out at a standstill of the vehicle combination in the recognized slope. The step of controlling the mechanical friction brake can be carried out in order to provide a retaining force acting on the trailer in the slope. The braking force acting on the vehicle trailer can provide the retaining force acting on the vehicle trailer in the slope. If the vehicle combination comes to a standstill in the slope, the braking force or the retaining force can be provided in order to counteract a downhill force of the trailer. The trailer can thus be prevented from rolling back during standstill, and any resulting load on the towing vehicle can be avoided. The mechanical friction brake can therefore also act as a parking brake. A force-free parking of the trailer in the slope can thus be provided with the method.

According to a further embodiment of the method, as a further step, it can comprise a recognition of a slope of the longitudinally inclined roadway on which the vehicle combination is located. The steps of the method can be carried out when the vehicle combination is accelerated in the recognized slope. Alternatively, or in addition to carrying out the steps of the method when the vehicle combination is standing still in the recognized slope, the steps of the method can also be carried out when the vehicle combination is accelerated in the recognized slope. The step of controlling the mechanical friction brake can be carried out in order to generate a retaining force acting on the vehicle trailer when the vehicle combination is accelerated as a function of the detected tensile or compressive force. If the combination is located in the slope, the mechanical friction brake can be triggered based on the tensile force detected when starting to drive the combination, which force acts on the trailer drawbar when starting in such a way that it is initiated in a force-balanced manner. Due to such a force-balanced initiation of the mechanical friction brake, a braking force curve acting on the vehicle trailer can be controlled, which reduces or eliminates a downhill force acting on the vehicle trailer. Due to such a force-balanced starting of the vehicle combination, the vehicle trailer can be prevented from rolling back, and the resulting tensile force in the vehicle combination acting on the towing vehicle can be avoided.

According to a further embodiment of the method, as a further step, it can comprise a recognition of a gradient of the longitudinally inclined roadway on which the vehicle combination is located. The gradient can be detected using the inclination sensor arranged on the vehicle trailer. The steps of the method can be carried out when the vehicle trailer is located on the recognized slope. The step of controlling the mechanical friction brake can be carried out in order to generate a retaining force acting on the vehicle trailer as a function of the detected tensile or compressive force in the slope. A compressive force acting on the towing vehicle due to a downhill force of the vehicle trailer can thus be reduced or eliminated.

According to a further embodiment of the method, the steps of the method can be carried out in at least a slope or a gradient in which the vehicle can be located on the longitudinally inclined roadway. In addition, it is conceivable that the steps of the method are also carried out when the vehicle combination is located on a non-inclined roadway, for example during a maneuvering of the vehicle combination. In the step of controlling the mechanical friction brake, the mechanical friction brake can be controlled in such a way that a blocking of a vehicle wheel of the vehicle trailer is prevented. An emergency braking of the vehicle combination can thus be carried out efficiently. For this purpose, the mechanical friction brake can be controlled in order to carry out a slip regulation of the vehicle wheel of the vehicle trailer. In this way, even during the emergency braking of the vehicle combination, a swerving of the vehicle trailer or a blocking of the vehicle wheel of the vehicle trailer can be prevented. In addition, a blocking of the vehicle wheel of the vehicle trailer upon changing roadway surface properties of the roadway can be prevented. Furthermore, in the step of controlling the mechanical friction brake, the mechanical friction brake can be controlled in such a way that the swerving movements of the vehicle trailer are prevented. The step of detecting the tensile or compressive force acting on the trailer drawbar can provide a basis for detecting the swerving movements of the vehicle trailer. In order to stabilize the vehicle combination, a plurality of mechanical friction brakes of the vehicle trailer can be actuated evenly in order to transmit a force acting on the vehicle trailer counter to the direction of travel of the vehicle combination and thus to stabilize the swerving vehicle trailer. Furthermore, in the step of controlling the mechanical friction brake, the mechanical friction brake can be controlled in such a way that a recuperating capacity of a recuperative brake of the vehicle combination is increased by adjusting a thrust force.

In a further aspect, the present invention relates to a system for operating a vehicle combination on a longitudinally inclined roadway. The system can be a sensor-actuated trailer braking system. According to one embodiment of the system, this system is configured so as to carry out the method according to the preceding aspect when the vehicle combination is located on the longitudinally inclined roadway. The system can be arranged on the vehicle trailer of the vehicle combination or can be retrofitted onto it. The system can comprise at least one device for carrying out at least one of the steps of the method.

The system comprises a force sensor arranged on a trailer drawbar of a vehicle trailer of the vehicle combination. The force sensor is configured so as to detect a tensile or compressive force acting on the trailer drawbar when the vehicle combination is located on the longitudinally inclined roadway. The system further comprises a control device, which is configured so as to generate a brake signal as a function of the detected tensile or compressive force when the vehicle combination is located on the longitudinally inclined roadway. The control device is further configured so as to trigger a mechanical friction brake of the vehicle trailer based on the generated brake signal such that the mechanical friction brake provides a braking force acting on the vehicle trailer when the vehicle combination is located on the longitudinally inclined roadway.

In a further aspect, the present invention relates to a vehicle trailer on which the system is arranged according to the preceding aspect. The vehicle trailer comprises a mechanical friction brake for decelerating a vehicle wheel of the vehicle trailer. The system is configured so as to trigger a mechanical friction brake of the vehicle trailer in order to provide a braking force.

In yet another aspect, the present invention relates to a vehicle combination having at least one vehicle trailer according to the preceding aspect. The vehicle trailer can be configured as described for the preceding aspects.

Embodiments of one aspect of the present invention may form corresponding methodological or structural embodiments of a further aspect of the present invention.

### BRIEF DESCRIPTION OF THE FIGURES

FIG. 1 shows a system for operating a vehicle combination having a vehicle trailer according to respective embodiments of the invention.

FIG. 2 shows a flowchart with steps of a method for operating the vehicle combination according to one embodiment of the invention.

### DETAILED DESCRIPTION

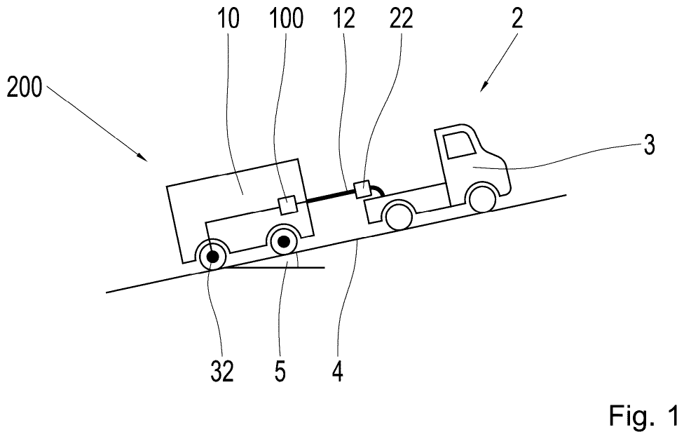

The vehicle combination 2 shown in FIG. 1 is located on a longitudinally inclined roadway 4. The longitudinally inclined roadway 4 has a slope 5, in which the vehicle combination 2 is located. The vehicle combination 2 comprises a towing vehicle 3 and a vehicle trailer 10, which is coupled to the towing vehicle 3.

The vehicle trailer 10 comprises a trailer drawbar 12, with which the vehicle trailer 10 is rigidly coupled to the towing vehicle 3 in relation to a longitudinal axis of the vehicle combination 2. The vehicle trailer 10 also comprises a force sensor 22, which is arranged on the trailer drawbar 12. The force sensor 22 is configured so as to detect a tensile or compressive force acting on the trailer drawbar 12 when the vehicle combination 2 is located in the slope 5 of the longitudinally inclined roadway 4.

The vehicle trailer 10 comprises a control device 100, which is configured so as to generate a brake signal. The vehicle trailer 10 also comprises a mechanical friction brake 32, which is configured so as to brake a vehicle wheel of the vehicle trailer 10 or to brake the vehicle trailer 10. The control device 100 is configured so as to trigger the mechanical friction brake 32 with the brake signal, so that the mechanical friction brake 32 provides a braking force acting on the vehicle trailer 10 and the vehicle combination 2.

The vehicle trailer 10 thus comprises a system 200 for decelerating the vehicle trailer 10 based on the detected tensile or compressive force, which system is arranged on the vehicle trailer 10. The system 200 comprises the force sensor 22, which is arranged on the trailer drawbar 12, and the control device 100, which is arranged on the vehicle trailer 10 and is connected to the mechanical friction brake 32 in order to trigger it.

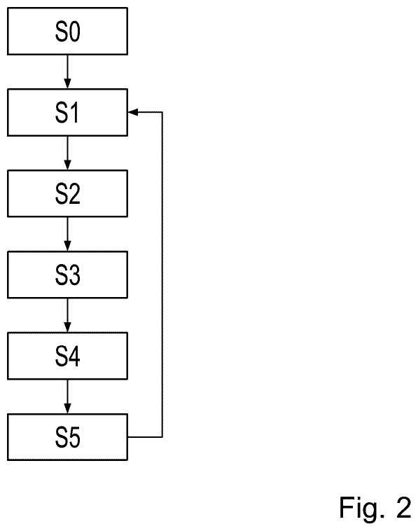

FIG. 2 shows steps of a method for operating the vehicle combination 2 on the longitudinally inclined roadway 4 in a chronological sequence of a flowchart according to one embodiment. The steps of the method are carried out by the system 200 on the vehicle trailer 10. According to one embodiment, the method is carried out self-sufficiently on the vehicle trailer 10, i.e., independently of a control of the towing vehicle 3.

In a first step S0 of the method, the slope 5 of the longitudinally inclined roadway 4 is recognized with an inclination sensor not shown in the figures. According to one embodiment, the inclination sensor is arranged on the vehicle trailer 10. In a further step S1 of the method, a tensile or compressive force acting on the trailer drawbar 12 of the vehicle trailer 10 of the vehicle combination 2 is detected using the force sensor 22 arranged on the trailer drawbar 12.

In a further step S2 of the method, the brake signal is generated as a function of the detected tensile or compressive force. The brake signal is generated in order to reduce or eliminate the acting tensile or compressive force. In a further step S3 of the method, the mechanical friction brake 32 of the vehicle trailer 10 is controlled based on the generated brake signal in such a way that a brake force acts on the vehicle trailer 10, which force is designed so as to reduce or eliminate the tensile or compressive force. The step of controlling is carried out during a standstill of the vehicle combination 2 in the slope 5 or upon an acceleration of the vehicle combination 2 in the slope 5.

In a further step S4 of the method, a braking force acting on the vehicle trailer 10 is thus provided, which, as a function of the detected tensile or compressive force, provides a retaining force acting on the vehicle trailer 10 in the slope 5. In a further step S5, the braking force acting on the vehicle trailer 10 is regulated in a control circuit via the steps S1 to S5 based on the generated brake signal in order to provide the braking force acting on the vehicle trailer 10 such that the tensile or compressive force acting on the trailer drawbar 12 is reduced or eliminated. With such a regulation, the vehicle combination 2 can be operated on the longitudinally inclined roadway 4 in a force-balanced manner, wherein the braking force provides a retaining force in the slope 5 of the longitudinally inclined roadway 4 of the vehicle trailer 10, which leads to a reduction or elimination of the tensile or compressive force.

### LIST OF REFERENCE NUMERALS

2 Vehicle combination
3 Towing vehicle
4 Longitudinally inclined roadway
5 Slope
10 Vehicle trailer
12 Trailer drawbar
22 Force sensor
32 Mechanical friction brake
100 Control device
200 System
S0 Slope recognition
S1 Force detection
S2 Signal generation
S3 Brake control
S4 Brake force provision
S5 Brake force regulation

1. A method for operating a vehicle combination (2) on a longitudinally inclined roadway (4), comprising:
providing the vehicle combination (2) on the longitudinally inclined roadway (4);
detecting (S1) a tensile or compressive force acting on a trailer drawbar (12) of a vehicle trailer (10) of the vehicle combination (2) using a force sensor (22) arranged on the trailer drawbar (12);
generating (S2) a brake signal as a function of the detected tensile or compressive force; and
controlling (S3) a mechanical friction brake (32) of the vehicle trailer (10) based on the generated brake signal for providing (S4) a braking force acting on the vehicle trailer (10).

2. The method according to claim 1, comprising:
determining a force reversal between a tensile force acting on the trailer drawbar (12) and a compressive force acting on the trailer drawbar (12), wherein, in the step of generating (S2) the brake signal, the brake signal is generated as a function of the determined force reversal.

3. The method according to claim 1, comprising:
regulating the braking force acting on the vehicle trailer (10) based on the generated brake signal for providing the braking force acting on the vehicle trailer (10).

4. The method according to claim 1, comprising:
recognizing (S0) a slope (5) of the longitudinally inclined roadway (4) on which the vehicle combination (2) is located, wherein the steps of generating (S2) the brake signal and controlling (S3) the mechanical friction brake (32) are carried out at a standstill of the vehicle combination (2) in the recognized slope (5), and
wherein controlling (S3) the mechanical friction brake (32) includes providing a retaining force acting on the vehicle trailer (10) in the slope (5).

5. The method according to claim 1, comprising:
recognizing (S0) a slope (5) of the longitudinally inclined roadway (4) on which the vehicle combination (2) is located,
wherein the steps of the method are carried out upon an acceleration of the vehicle combination (2) in the recognized slope (5),
wherein controlling (S3) the mechanical friction brake (32) includes generating a retaining force acting on the vehicle trailer (10) when the vehicle combination (2) is accelerated as a function of the detected tensile or compressive force.

6. The method according to claim 1, comprising:
recognizing (S0) a slope of the longitudinally inclined roadway (4) on which the vehicle combination (2) is located,
wherein the steps of the method are carried out when the vehicle combination (2) is located in the recognized gradient,
wherein controlling (S3) the mechanical friction brake (32) includes generating a retaining force acting on the vehicle trailer (10) as a function of the detected tensile or compressive force in the slope.

7. A system (200) for operating a vehicle combination (2) on a longitudinally inclined roadway (4), the system comprising:
a force sensor (22) arranged on a trailer drawbar (12) of a vehicle trailer (10) of the vehicle combination (2), wherein the force sensor (22) is configured to detect a tensile or compressive force acting on the trailer drawbar (12) when the vehicle combination (2) is located on the longitudinally inclined roadway (4); and
a control device (100) configured to generate a brake signal as a function of the detected tensile or compressive force when the vehicle combination (2) is located on the longitudinally inclined roadway (4)
wherein the control device (100) is further configured to trigger a mechanical friction brake (32) of the vehicle trailer (10) based on the generated brake signal in such a way that the mechanical friction brake (32) provides a braking force acting on the vehicle trailer (10) when the vehicle combination (2) is located on the longitudinally inclined roadway (4).

8. The system (200) according to claim 7, wherein the system (200) is configured so as to carry out the method according to claim 1.

9. A vehicle trailer (10) on which the system (200) according to claim 7 is arranged, wherein the system is configured to trigger a mechanical friction brake (32) of the vehicle trailer (10) for providing a braking force.

10. A vehicle combination (2) comprising:
at least one vehicle trailer (10)
the system (200) according to claim 7 arranged on the at least one vehicle trailer,
wherein the system is configured to trigger a mechanical friction brake (32) of the at least one vehicle trailer (10) for providing a braking force.
